(19) United States
(12) Patent Application Publication
(10) Pub. No.: US 2003/0122061 A1
(43) Pub. Date: Jul. 3, 2003

(54) Optical device, optical device module and carrier for optical device

(76) Inventors: Minoru Kawano, Tokyo (JP); Kiyohide Sakai, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/202,898

(22) Filed: Jul. 26, 2002

(30) Foreign Application Priority Data
Dec. 27, 2001 (JP) 2001-396513

(51) Int. Cl. H01J 40/14

(52) U.S. Cl. 250/214 R

(57) ABSTRACT

An optical device has a semiconductor laser for emitting a laser beam, and a photodetector having a photodetecting face to receive the laser beam emitted from the semiconductor laser. The photodetector is relatively disposed with respect to the semiconductor laser such that a normal line of the photodetecting face crosses an emission direction of the laser beam with an angle in a range of not less than 60 degrees but less than 90 degrees.

The present application is based on Japanese Patent Application No. 2001-396513 filed on Dec. 27, 2001, which is incorporated herein by reference.

### BACKGROUND OF THE INVENTION

1. Field of the Invention

The present invention relates to an optical device which comprises a semiconductor laser for emitting a laser beam and a photodetector for monitoring the laser beam to control the output of the semiconductor laser. The present invention also relates to an optical device module having the optical device and a carrier for mounting the optical device thereon.

2. Description of the Related Art

FIG. 32 shows an example of an optical device module 100 pertinent to the related art. A block 107 as a supporting base member is mounted within a package 110, and a semiconductor laser 101 for emitting a laser beam is mounted on the block 107 through a heat sink 102. A monitor photodetector 105 to control the output of the laser beam is also mounted on the block 107 through a support block 106. The semiconductor laser 101 and the heat sink 102 are connected via a wire 108 to secure the electrical connection. The photodetector 105 and the support block 106 are also connected via a wire 109. The semiconductor laser 101 emits forward beam A and backward beam B. The forward beam A is condensed by a lens member 111 fixed on the package 110 and made incident on the external fiber, or the like.

FIGS. 33A and 33B show an enlarged perspective view and an enlarged side view of the semiconductor laser 101 and the photodetector 105.

FIGS. 34A to 34H show a manufacturing process of the above optical device module. As shown in FIGS. 34A to 34C, after the photodetector 105 is fixed on the support block 106 by solder or the like, the photodetector 105 and the support block 106 are connected via the wire 109. Next, arrangement of the support block 106 mounted with the photodetector 105 is changed as shown in FIG. 34D, and the support block 106 is fixed on the block 107 by solder as shown in FIG. 34H. Meanwhile, the semiconductor laser 101 is fixed on the heat sink 102 by solder or the like, and the semiconductor laser 101 and the heat sink 102 are connected via the wire 108 as shown in FIGS. 34E to 34G. Finally, the heat sink 102 is fixed on the block 107 as shown in FIG. 34H.

As described above, arrangement of the support block 106 mounted with the photodetector 105 is changed to achieve the efficient reception of the backward beam B of the semiconductor laser 101. In other words, it is necessary to change the arrangement of the support block 106 to receive the backward beam B efficiently.

In contrast, die-bonding (fixation) and wire-bonding of the photodetector 105 on the support block 106 should be conducted on a plane as shown in FIGS. 34A to 34C. Accordingly, after the die-bonding and wire-bonding of the photodetector 105 within the plane, the support block 106 should be rotated by 90 degrees and then should be fixed on the block 107 along with positioning for the reception of the backward beam B of the semiconductor laser 101. These processes cause low manufacturing efficiency.

To solve the above problem, there has been proposed a mounting method such that both the semiconductor laser 101 and the monitor photodetector 105 are mounted on the surface of a single heat sink 114 as shown in FIGS. 35A and 35B. In this structure, the backward beam B is received by a photodetecting layer 122 of the photodetector 105 to be converted into electric current. However, the backward beam B is made incident on the photodetecting layer 122 substantially in parallel under this structure. Therefore, the amount of the received beam is small, and the electric current value after conversion is consequently made small. This leads to less monitor current to control the output of the semiconductor laser 101.

### SUMMARY OF THE INVENTION

The present invention provides a first optical device comprising a semiconductor laser for emitting a laser beam, and a photodetector having a photodetecting face to receive the laser beam emitted from the semiconductor laser. In the first optical device, the photodetector is relatively disposed with respect to the semiconductor laser such that a normal line of the photodetecting face crosses an emission direction of the laser beam with an angle in a range of not less than 60 degrees but less than 90 degrees.

In the above first optical device, the wire bonding surface of the photodetector and another surface on which the wire is to be bonded are located nearly in parallel with each other. Consequently, while easiness of die boding and wire bonding is secured, reflectance of the laser beam with respect to the photodetecting face is decreased and then the value of the monitor electric current can be enhanced.

The present invention also provides a second optical device comprising a semiconductor laser for emitting a laser beam, and a photodetector having a photodetecting face to receive the laser beam emitted from the semiconductor laser and an outermost layer being formed on the photodetecting face. In the second optical device, the photodetector is relatively disposed with respect to the semiconductor laser such that an incident angle of the laser beam with respect to the photodetecting face of the photodetector is set in a range of larger than 0 degree but less than 90 degrees. Also, a combination of a refractive index and a thickness of the outermost layer is set in accordance with a wavelength of the laser beam such that a reflectance of the laser beam indicates a minimum value at the incident angle of the laser beam or at the vicinity of the incident angle.

In the above second optical device, in a situation where the incident angle of the laser beam is predetermined for the design limitation of the device, it makes possible to suppress the reflection of the laser beam by adjusting the normalized film thickness (combination of the refractive index and the thickness) of the outermost layer appropriately in accordance with the wavelength of the laser beam. Even in a case where the design freedom of the optical device is low, sufficient monitor current to control the output of the semiconductor laser can be obtained by such adjustment.

Further, the present invention provides an optical device module comprising a case, an optical device mounted on a bottom of the case, a cover covering an upper face of the case, a sealing glass covering a through hole formed in one wall of the case from an interior of the case, a lens holder attached on an outer side of one wall of the case at a circumference of the through hole and a second lens accommodated in the lens holder. The optical device in the optical device module is similar to the first or second optical device aforementioned.

This optical device module has effect similar to the effect of the above optical devices.

Still further, the present invention provides a carrier for an optical device, which is adapted for mounting thereon a semiconductor laser and a photodetector to monitor the laser beam emitted from the semiconductor laser to control an output of the laser beam. This carrier comprises a bottom, a first flat face formed opposite to the bottom and being adapted for mounting the semiconductor laser thereon, and an inclination groove having an inclination face and a rising face. The rising face is formed from the first flat face toward the bottom, and the inclination face is formed to be inclined with respect to the first flat face and being adapted for mounting the photodetector thereon.

This carrier can provide a preparatory ambience for making easier die boding and wire bonding of the photodetector and enhancing the monitor current value of the laser beam.

Features and advantages of the invention will be evident from the following detailed description of the preferred embodiments described in conjunction with the attached drawings.

### BRIEF DESCRIPTION OF THE DRAWINGS

In the accompanying drawings:

FIGS. 1A and 1B show a perspective view and a side view of an optical device according to a first embodiment of the present invention;

FIG. 2 shows a sectional view of the general InGaAs photodectector;

FIG. 3 shows a graph showing a relationship between the laser beam incident angle and the calculated laser beam reflectance in the general InGaAs photodectector;

FIG. 4 shows a graph showing a relationship between the laser beam incident angle and the calculated laser beam reflectance in the InGaAs photodectector adapted for the present invention;

FIG. 5 shows a sectional view of the InGaAs photodectector adapted for the present invention;

FIG. 6 schematically shows a relationship among the photodectector, the incident angle and the normal line of the photodetecting face

FIG. 7 shows a graph showing a relationship between the normalized film thickness and the calculated laser beam reflectance;

FIG. 8 shows a graph showing a relationship between the laser beam incident angle and the calculated laser beam reflectance at the normalized film thickness x=0.2;

FIG. 9 shows a graph showing a relationship between the laser beam incident angle and the calculated laser beam reflectance at the normalized film thickness x=0.25;

FIG. 10 shows a graph showing a relationship between the laser beam incident angle and the calculated laser beam reflectance at the normalized film thickness x=0.3;

FIG. 11 shows a graph showing a relationship between the laser beam incident angle and the calculated laser beam reflectance at the normalized film thickness x=0.35;

FIG. 12 shows a graph showing a relationship between the laser beam incident angle and the calculated laser beam reflectance at the normalized film thickness x=0.4;

FIG. 13 shows a graph showing a relationship between the laser beam incident angle and the calculated laser beam reflectance at the normalized film thickness x=0.45;

FIG. 14 shows a sectional view of the InGaAs photodectector having an outermost layer with the double layer structure;

FIG. 15 shows a sectional view of the InGaAs photodectector having an outermost layer with the triple layer structure;

FIG. 16 shows a graph showing a relationship between the laser beam incident angle and the calculated laser beam reflectance in a photodectector where the first layer is formed of Si₃N₄ film and the second layer is formed of SiO₂ film in the structure shown in FIG. 14;

FIG. 17 shows a graph showing a relationship between the laser beam incident angle and the calculated laser beam reflectance in a photodectector where the first layer is formed of Si₃N₄ film and the second layer is formed of SiO₂ film in the structure shown in FIG. 14;

FIG. 18 shows a graph showing a relationship between the laser beam incident angle and the calculated laser beam reflectance in a photodectector where the first layer is formed of Si₃N₄ film and the second layer is formed of Al₂O₃ film in the structure shown in FIG. 14;

FIG. 19 shows a graph showing a relationship between the laser beam incident angle and the calculated laser beam reflectance in a photodectector where the first layer is formed of Si₃N₄ film and the second layer is formed of Al₂O₃ film in the structure shown in FIG. 14;

FIG. 20 shows a graph showing a relationship between the laser beam incident angle and the calculated laser beam reflectance in a photodectector where the first layer is formed of Si₃N₄ film, the second layer is formed of Al₂O₃ film and the third layer is formed of SiO₂ film in the structure shown in FIG. 15;

FIG. 21 shows a graph showing a relationship between the laser beam incident angle and the calculated laser beam reflectance in a photodectector where the first layer is formed of Si₃N₄ film, the second layer is formed of Al₂O₃ film and the third layer is formed of SiO₂ film in the structure shown in FIG. 15;

FIG. 22 shows a graph showing a relationship between the displacement amount of the photodectector and the reception rate percentage of the laser beam;

FIGS. 23A and 23B show a perspective view and a side view of an optical device according to a second embodiment of the present invention;

FIGS. 24A and 24B show a perspective view and a side view of an optical device according to a third embodiment of the present invention;

FIG. 25 shows a side view of an optical device according to a fourth embodiment of the present invention;

FIG. 26A shows a side view of an optical device according to a fifth embodiment of the present invention, and FIG. 26B shows a corner roundness formed on the substrate;

FIG. 27 shows a sixth embodiment of the present invention where an optical device is bonded to a package by wire bonding;

FIG. 28 shows a seventh embodiment of the present invention where an optical device is directly bonded to a package by wire bonding;

FIG. 29 shows a perspective view of an optical device according to an eighth embodiment of the present invention;

FIGS. 30A and 30B show a ninth embodiment of the present invention where an optical device is accommodated in a case to constitute an optical module;

FIGS. 31A and 31B show a perspective view and a side view of a carrier for an optical device according to the present invention;

FIG. 32 shows a side view of an optical device module pertinent to the related art;

FIGS. 33A and 33B show an enlarged perspective view and an enlarged side view of the semiconductor laser and the photodetector in the optical device module pertinent to the related art;

FIGS. 34A to 34H show a manufacturing process of the optical device module pertinent to the related art; and

FIGS. 35A and 35B show a perspective view and a side view of an optical device pertinent to the related art.

### DETAILED DESCRIPTION OF THE PREFERRED EMBODIMENTS

The present invention will be described hereinafter with reference to the drawings.

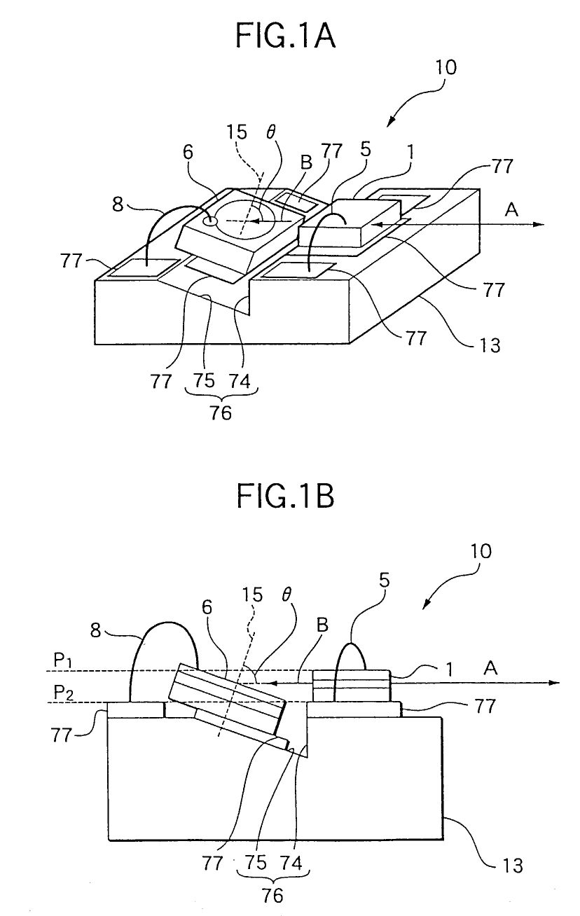

As shown in FIGS. 1A and 1B, an optical device 10 according to the first embodiment of the present invention has at least a semiconductor laser 1 and a monitor photodetector 6. The semiconductor laser 1 and the monitor photodetector 6 are fixed on a single substrate 13 as a heat sink by metallize plates 77 and electrically coupled with the substrate 13 by wires 5, 8 via the metallize plates 77, respectively.

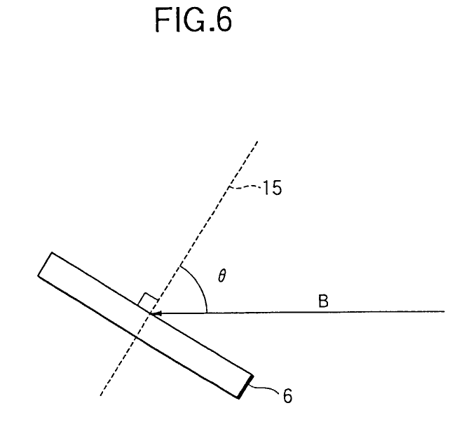

As shown in FIGS. 1A, 1B and 6, the photodetector 6 is mounted on the substrate 13 so that a normal line 15 of a photodetecting face 48 of the photodetector 6 intersects with the direction of the backward beam B of the semiconductor laser 1 with an angle θ. In other words, the photodetector 6 is relatively disposed with respect to the semiconductor laser 1 so that the normal line 15 of the photodetecting face intersects with an emission direction of a laser beam (backward beam B) with an angle θ. The emission direction of the laser beam corresponds to an extension direction of the longitudinal direction of an active layer within the semiconductor laser 1. From another aspect, the energy distribution in the diameter direction of the laser beam complies with Gaussian distribution, and the direction indicating the maximum energy intensity under Gaussian distribution corresponds to the emission direction of the laser beam (direction of tracing the maximum intensity center of the laser beam).

The incident angle θ of the laser beam determines the inclination of the photodetecting face of the monitor photodetector 6. From the standpoint of easiness of die bonding and wire bonding for the photodetector, it is preferable to set the incident angle θ close to 90 degrees. In contrast, from the standpoint of obtaining sufficient monitor current to control output of the semiconductor laser 1, it is preferable to set the incident angle θ close to 0 degrees. The alignment of the monitor photodetector 6 needs to meet these conflicting conditions. Hereinafter, the structure of the optical device which meets these conditions is explained.

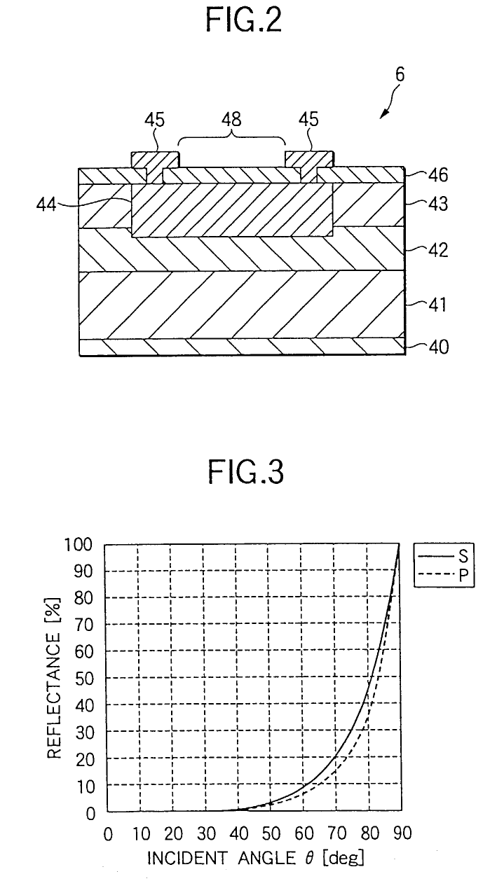

FIG. 2 shows a structure of a general InGaAs monitor photodectector 6. The InGaAs monitor photodectector 6 has an n-type InP substrate 41, an InGaAs optical absorption layer 42 of the high-resistance intrinsic semiconductor layer (i layer) formed on the substrate 41, an n-type InGaAs layer 43 formed on the optical absorption layer 42, and a p-type impurity diffused layer 44 formed from the upper surface of the InGaAs layer 43 to the interior of the optical absorption layer 42. The p-type impurity diffused layer 44 is obtained by doping a p-type impurity such as Zn into InGaAs. Further, an Si₃N₄ film 46 as an outermost layer is formed on the n-type InGaAs layer 43, and a p electrode 45 and an n electrode 40 are respectively formed on the Si₃N₄ film 46 and on the lower surface of the n-type InP substrate 41.

While applying predetermined voltage between the p electrodes 45 and an n electrode 40, if light is made incident on the photodetecting face 48, which corresponds to an area surrounded by the p electrode 45 on the p-type impurity diffused layer 44, electric current flows between the p electrode 45 and the n electrode 40. In the optical device, the backward beam B of the semiconductor laser 1 is made incident on the photodetecting face 48 on the p-type impurity diffused layer 44 and converted into electric current. This electric current is used as monitor current for controlling output of the semiconductor laser 1.

The Si₃N₄ film 46 as an outermost layer is employed for controlling the reflectance of the photodetecting face 48 where the laser beam is made incident on. If the refractive index of the Si₃N₄ film 46 is n and the wavelength of the laser beam is λ, the reflectance of the laser beam from the normal line direction with respect to the photodetecting face is made minimum in the condition that the film thickness of the Si₃N₄ film 46 is set to be made equal to λ/(4n), and it becomes nearly 0%. On the other hand, if the refractive index of the photodetecting face is Nₐ and the refractive index of a space through which the laser beam travels is N_{b}, the reflectance of the laser beam incident from the normal line direction with respect to the photodetecting face is made minimum and it becomes nearly 0% in the condition that the refractive index of the outermost layer is set to √(Nₐ×N_{b}). Hereupon, the refractive index of the photodetecting face 48 is equal to that of the p-type impurity diffused layer 44, which is a refractive index of InGaAs, and Nₐ≈3.4. Also, the refractive index of the space through which the laser beam travels is equal to that of air, and N_{b}≈1.0. Accordingly, the optimum refractive index of the outermost layer becomes √(3.4×1.0)=1.84 on calculation. The refractive index of the p-type impurity diffused layer 44 of InGaAs is about 3.4, which is larger than the foregoing optimum refractive index. In contrast, the refractive index of the Si₃N₄ film is about 2.0, which is closer to the foregoing optimum refractive index. Therefore, in the general InGaAs monitor photodectector 6, the Si₃N₄ film 46 having a refractive index which is closer to the foregoing optimum refractive index is adapted for its outermost layer. This outermost layer plays a role of reducing the reflectance of the laser beam from the normal line direction with respect to the photodetecting face.

FIG. 3 shows a relationship between the incident angle θ and the calculated laser beam reflectance, wherein the wavelength of the laser beam is 1310 nm, the refractive index of the photodetecting face is 3.4 (InGaAs), the refractive index of a space through which the laser beam travels is 1.0 (air), the refractive index of the outermost layer of the monitor photodetector is 1.84(=√(3.4×1.0)) for exhibiting minimum reflectance, and the film thickness of the outermost layer is 178 nm (λ/(4n)) for exhibiting minimum reflectance. The incident angle θ is an angle defined between a normal line of the photodetecting face of the photodetector and incident direction of the laser beam by as shown in FIG. 6. The reflectance can be calculated by the following general equation (1) for calculating reflectance R of a thin film formed on a substrate (for example, refer to “Basis and Application of Optically Coupled System for Optical Device” published by Gendai Kougakusha, 1991).

R={r²₁₂+r²₂₃+2r₁₂r₂₃ cos(2β)}/{1+r²₁₂r²₂₃+2r₁₂r₂₃ cos(2β)} (1)

β: retardation between two reflection waves respectively caused by the front surface and the back surface of the thin film (in the external medium)

r₁₂:amplitude reflectance between the medium and the thin film

r₂₃ amplitude reflectance between the thin film and the substrate

The graph in FIG. 3 shows reflectance of two kinds of electromagnetic wave, an S-wave with an electric field component and a P-wave with a magnetic field component, each parallel with the interface. The beam emitted from the end face of the semiconductor laser is made into an S-wave owing to the reflectance of the end face of the semiconductor laser. Accordingly, the reflectance can be inspected just in view of the S-wave. Hereinafter, the reflectance of the laser beam is reviewed with respect to the S-wave.

When light is made incident on the photodetecting face of the photodetector perpendicularly, e.g., the incident angle being 0 degrees, reflectance becomes 0%. As the incident angle becomes larger, the reflectance is drastically increased, and at the incident angle θ=70° or 80°, it is about 20% or 46%. The rate of the light reflected on the photodetecting face becomes larger, and the rate of the receivable laser beam decreases.

In the optical device according to the first embodiment shown in FIG. 1, the angle of inclination of the mounting face for the photodetector 6 is set in a range around 60 degrees to 70 degrees so that die-bonding and wire-bonding of the monitor photodetector 6 on the substrate 13 should be made easier. According to the ordinary design for the refractive index of the outermost layer (=√(Nₐ×N_{b})) and the film thickness (=λ/(4n)), which is an ordinary method for reducing the reflectance on the photodetecting face of the photodetector 6, reflection on the photodetecting face is drastically increased and only a small monitor current can be gained. Consequently, it would be impossible to meet both of easiness of die boding and wire bonding, and ensuring the monitor electric current. Even if the film thickness of the outermost layer is modified, this result remains.

Next, the reflectance in the specific case is reviewed, where the refractive index of the outermost layer is set to N which is smaller than the ordinary optimum value (=(Nₐ×N_{b})) and its film thickness is set to be larger than the ordinary optimum value (=λ/(4(Nₐ×N_{b})).

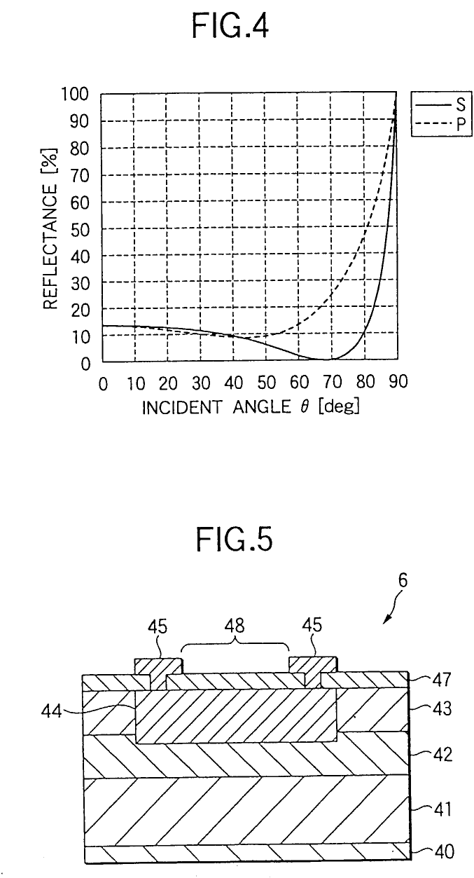

FIG. 4 shows a relationship between the incident angle θ and the calculated laser beam reflectance, wherein the wavelength of the laser beam is 1310 nm, the refractive index of the photodetecting face is 3.4 (InGaAs), the refractive index of a space through which the laser beam travels is 1.0 (air), the refractive index of the outermost layer of the monitor photodetector is N=1.45 which is smaller than 1.84(=√(3.4×1.0)), and the film thickness of the outermost layer is 300 nm which is larger than 178 nm (=(λ/(4√(3.4×1.0))). The reflectance can be calculated by the aforementioned equation (1).

According to FIG. 4, the reflectance at the incident angle θ=70° is 0.3%, so improvement of the monitor current can be expected nearly by 20% as compared with the reflectance 20% shown in FIG. 3. Similarly, the reflectance at the incident angle θ=80° is 12%, so improvement of the monitor current can be expected nearly by 34% as compared with the reflectance 46% shown in FIG. 3.

On the basis of the aforementioned result, FIG. 5 shows an example of a monitor photodectector 6 adapted for the present invention. The monitor photodectector 6 has an n-type InP substrate 41, an InGaAs optical absorption layer 42 of the high-resistance intrinsic semiconductor layer (i layer) formed on the substrate 41, an n-type InGaAs layer 43 formed on the optical absorption layer 42, and a p-type impurity diffused layer 44 formed from the upper surface of the InGaAs layer 43 to the interior of the optical absorption layer 42. The p-type impurity diffused layer 44 is obtained by doping p-type impurity such as Zn into InGaAs.

Further, a dielectric SiO₂ film 47 as an outermost layer is formed on the n-type InGaAs layer 43, and a p electrode 45 and an n electrode 40 are respectively formed on the SiO₂ film 47 and on the lower surface of the n-type InP substrate 41. The SiO₂ film 47 has a refractive index 1.45 and a film thickness 300 nm.

The monitor photodectector 6 having the SiO₂ film 47 provided on its outermost surface is mounted on an inclination groove 76 on the substrate 13 as shown in FIGS. 1A and 1B to realize the incident angle θ=70°. This inclination groove 76 is constituted by a rising face 74 extended substantially perpendicularly from the end of the flat face on which the semiconductor laser 1 is mounted toward the bottom of the substrate 13, and an inclination face 75 extended obliquely from the end of another flat face toward the bottom of the substrate 13. By setting the inclination angle of the inclination face 75 precisely, the monitor photodectector 6 can be disposed accurately in view of its inclination angle.

In the embodiment, a wire bonding surface of the photodetector 6 and a wire bonding surface of the substrate are located nearly in parallel. Consequently, while easiness of die boding and wire bonding of the photodetector 6 on the substrate 13 is secured, reflectance of the laser beam can be decreased as shown in FIG. 4 and then the value of the monitor electric current can be enhanced. In addition, reduction of thickness of the optical device can be achieved.

Further, the inclination face may be formed to achieve the incident angle θ=60°. In the example in FIG. 4, although this design is disadvantageous as compared with the case of θ=70° from the aspect of easiness of both die and wire bonding and improvement of the monitor current, it can obtain larger monitor current than in the case of θ=50° or 40°. In addition, excellent reflection property can be obtained at the vicinity of the incident angle θ=60° in the examples in FIGS. 17 to 19 as hereinafter explained.

Moreover, virtual planes P1 and P2 in FIG. 1B specifically illustrate the easiness of wire bonding. The semiconductor laser 1 and the monitor photodetector 6 are bonded substantially at the same level with reference to the substrate 13. In other words, wire bonding for both of the semiconductor laser 1 and the monitor photodetector 6 can be conducted simultaneously within a single plane P1 or a single plane P2. As a result, this structure facilitates the wire bonding process.

Still further, the semiconductor laser 1 and the monitor photodetector 6 are disposed on a single substrate 13. Blocks described in the related art can be omitted under this structure. Materials for the substrate are not limited to specific ones, but Si, for example, may be adapted. When the semiconductor laser 1 and the monitor photodetector 6 are mounted on the substrate 13, it is necessary to form positioning markers on the substrate 13.

The positioning markers can be formed on the Si substrate by chemical etching.

Next, the property of the outermost layer will be discussed in more detail.

The film thickness and the refractive index of the outermost layer are independent values, and each of these two values may be optional values independently. Hereupon, both of two values are linked and put together into one concept to thereby facilitate review of the property of the outermost layer. According to the present invention, a normalized film thickness x of the outermost layer is investigated. When d is a film thickness of the outermost layer, N is a refractive index of the outermost layer, and λ is a wavelength of the laser beam, the normalized film thickness x is calculated by x=d/(λ/N)=(N×d)/λ. Namely, the wavelength of the laser beam is compensated by the refractive index of the outermost layer, and the ratio of the film thickness to the compensated wavelength is represented by the normalized film thickness x. By means of this method, the optical property of the outermost layer can be evaluated based on a single value, normalized film thickness.

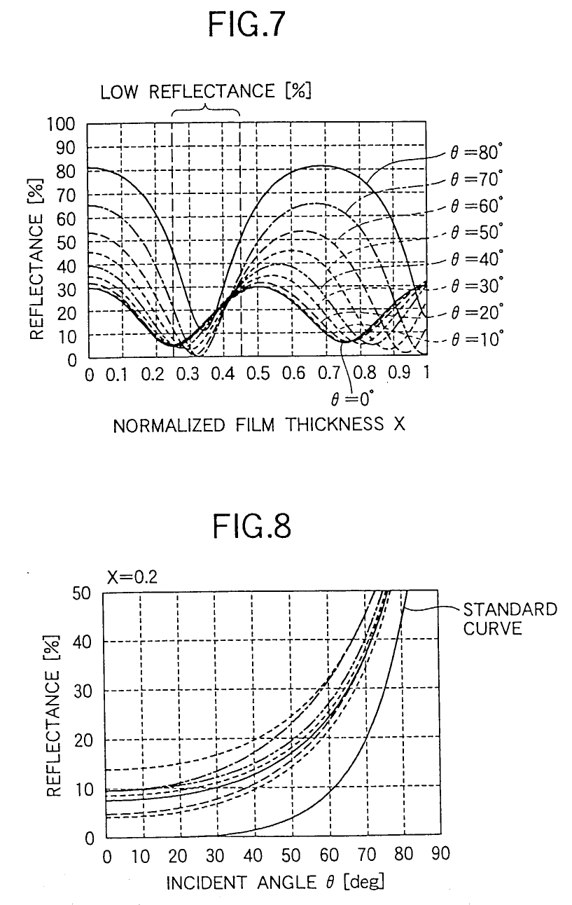

FIG. 7 is a graph showing a relationship between the normalized film thickness x and the calculated reflectance of the laser beam. The reflectance may be calculated by the aforementioned equation (1). In the example, assuming that the outermost layer is formed of SiO₂ film, N=1.45 is employed. Further, reflectance of each of the photodetetors in which the incident angle of the laser beam is changed by 10 degrees in the range from 0 to 80 degrees.

As indicated in the graph, it can be observed that the reflectance indicates a minimum value in the range of x from about 0.2 to about 0.45. Accordingly, it can be expected that an excellent outermost layer may be obtained in this x range from the aspect of small reflection. The reflectance in the vicinity of this range will be further investigated hereinafter.

FIGS. 8 to 13 show graphs showing a relationship between the incident angle θ and the calculated reflectance, in each of which the normalized film thickness x is set to 0.2, 0.25, 0.3, 0.35, 0.4, and 0.45. Further, in each photodetector having a specific normalized film thickness x, reflectance in plural cases where the refractive index N is changed to be 1.3, 1.4, 1.45, 1.5, 1.8, 2.0 and 2.4 is calculated.

In addition, under the condition that the laser beam is made incident from the normal line direction of the photodetecting face of the photodetector (incident angle θ=0°), reflectance of the photodetector having an optimum outermost layer obtained by the ordinary method is indicated as a standard curve in each graph. The refractive index is set to 1.84 and the film thickness is set to 178 nm as aforementioned. It could be estimated that if a reflectance smaller than the standard curve is obtained in the range of large incident angles, while easiness of die boding and wire bonding is secured, sufficient monitor current can be retained for controlling the output of the semiconductor laser.

As shown in FIG. 8, at x=0.2, there is no photodetector which indicates smaller reflectance than the standard curve.

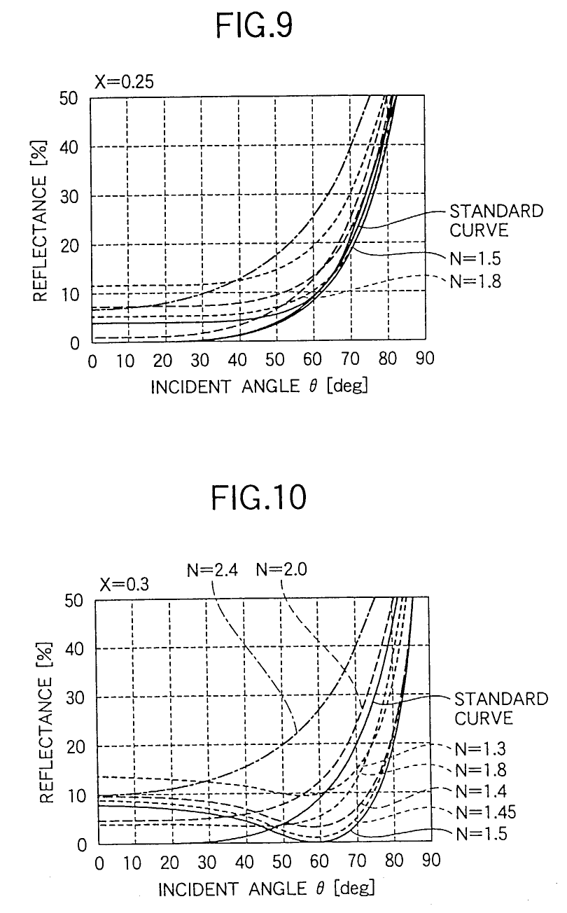

As shown in FIG. 9, at x=0.25, photodetectors each having an outermost layer with refractive index N=1.5 or 1.8 indicate smaller reflectance than the standard curve in the angle range larger the predetermined incident angle.

As shown in FIG. 10, at x=0.3, photodetectors each having an outermost layer with refractive index N=1.3, 1.4, 1.45, 1.5 or 1.8 indicate smaller reflectance than the standard curve in the angle range larger the predetermined incident angle.

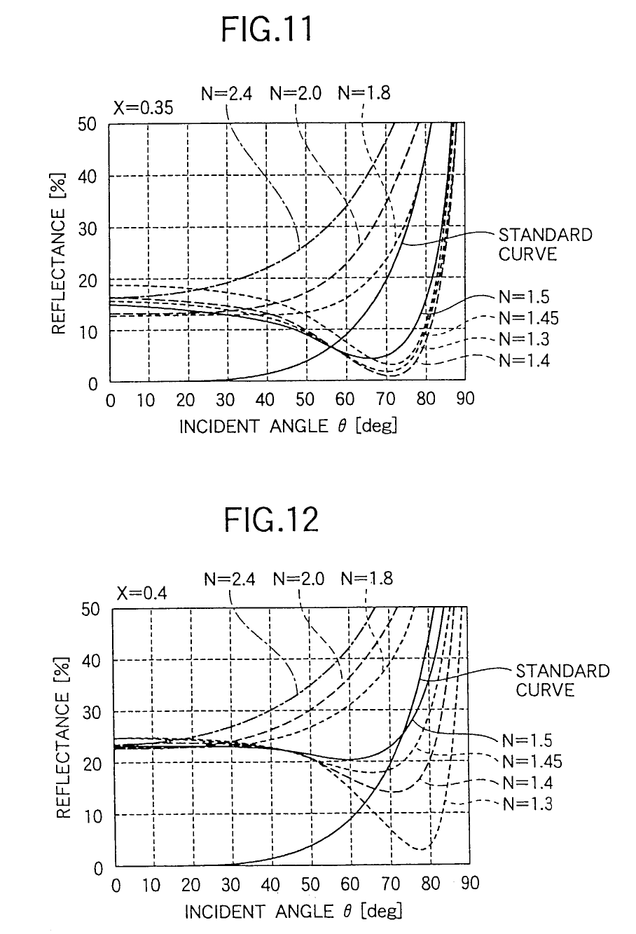

As shown in FIG. 11, at x=0.35, photodetectors each having an outermost layer with refractive index N=1.3, 1.4, 1.45 or 1.5 indicate smaller reflectance than the standard curve in the angle range larger the predetermined incident angle.

As shown in FIG. 12, at x=0.4, photodetectors each having an outermost layer with refractive index N=1.3, 1.4, 1.45 or 1.5 indicate smaller reflectance than the standard curve in the angle range larger the predetermined incident angle.

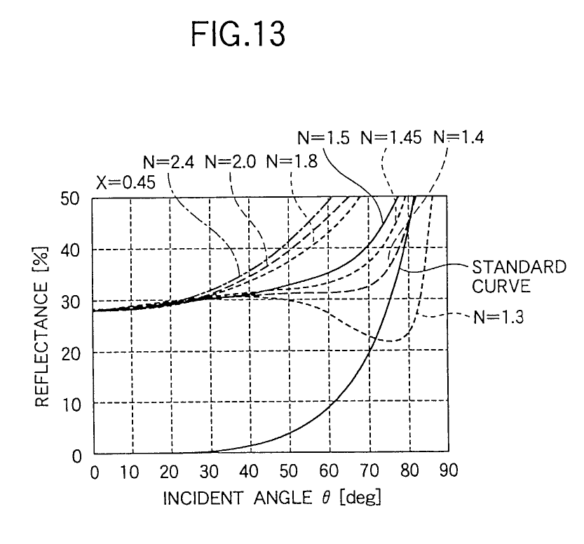

As shown in FIG. 13, at x=0.45, a photodetectors having an outermost layer with refractive index N=1.3 indicates smaller reflectance than the standard curve in the angle range larger the predetermined incident angle. Hereupon, if θ=70 the reflectance is not smaller than the standard curve, but by increasing θ to about 72°, reflectance smaller than the standard curve can be obtained.

Accordingly, in the range of the normalized film thickness x not less than 0.25 but less than 0.45, it is possible to obtain a large reception rate of the laser beam and large monitor current for controlling the output of the semiconductor laser. Consequently, output control of the semiconductor laser can be performed accurately. In the case where the incident angle θ is set to 70 degrees, by adjusting the normalized film thickness x to not less than 0.25 but less than 0.45, large monitor current can be obtained.

Incidentally, as aforementioned, the Si₃N₄ film as an outermost layer employed in the general InGaAs monitor photodectector 6 has a refractive index close to the optimum value with respect to the laser beam from the normal line direction of the photodetecting face. However, its refractive index is likely to be too large especially in the range of θ adapted for the present invention. In contrast, the Si₃N₄ film as the outermost layer is useful in view of passivation effect. Thus, the Si₃N₄ film plays as a role of preventing diffusion of As atoms or the like from the surface of the optical device during the high temperature treatment in the manufacturing process. To apply such useful film, optical devices which employ not only the Si₃N₄ film but also other kinds of films are investigated. In other words, an outermost layer which adopts a multi-layer structure is investigated.

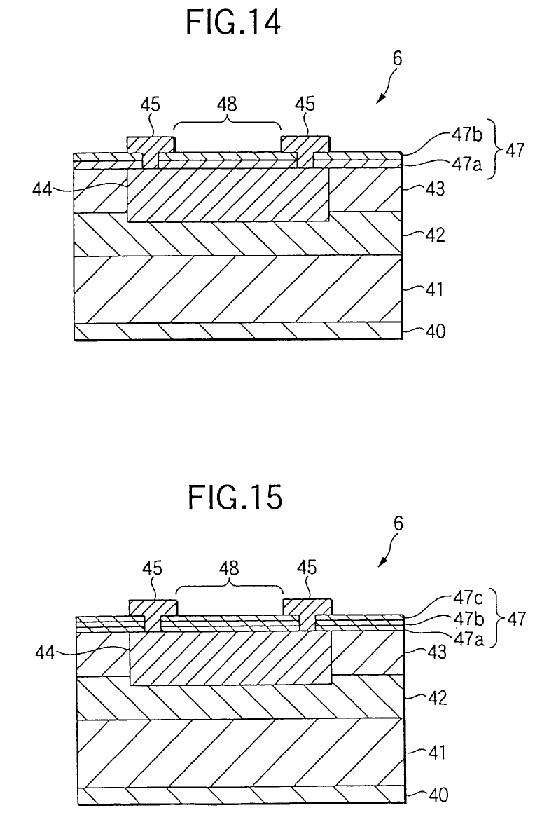

FIG. 14 shows a photodectector 6 where the outermost layer 47 is formed of a first layer 47a and a second layer 47b. FIG. 15 shows a photodectector 6 where the outermost layer 47 is formed of a first layer 47a, a second layer 47b and a third layer 47c.

In the case where material having a large refractive index such as Si₃N₄ film is adapted for one of laminated sub-layers, it can be considered to employ another material having a smaller refractive index for another sub-layer. Thus, if one sub-layer has a refractive index larger than the optimum value √(Nₐ×N_{b}) obtained by the ordinary manner, another sub-layer has a refractive index smaller than √(Nₐ×N_{b}) An optical device which has an outermost layer with multi-layer structure under such assumption was investigated. Especially, the outermost layer having plural laminated dielectric layers was investigated.

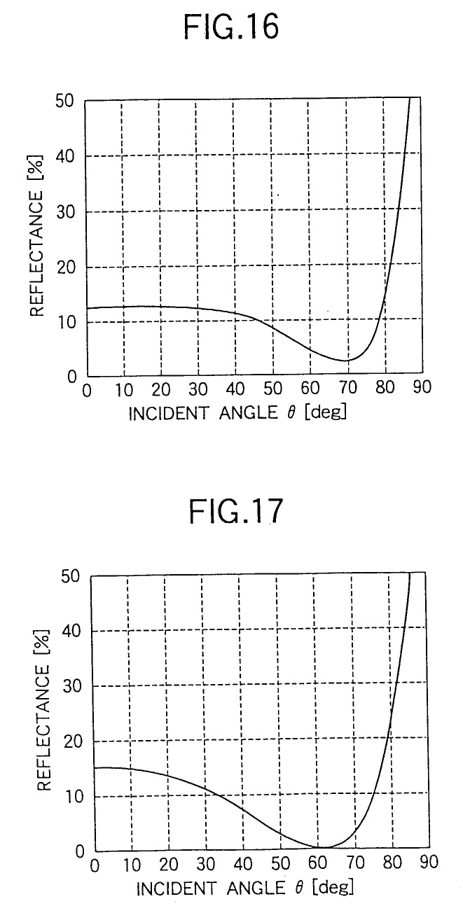

FIG. 16 shows a graph showing a relationship between the incident angle θ and the calculated reflectance in the photodectector 6 where the first layer 47a is formed of Si₃N₄ film (refractive index: 2.0) and the second layer 47a is formed of SiO₂ film (refractive index: 1.45) in the structure shown in FIG. 14. The reflectance can be calculated by modification of the aforementioned equation (1). The Si₃N₄ film is located on the side closer to the photodetecting face and the SiO₂ film is located on the side closer to the outer surface of the optical device in order to utilize passivation effect of the Si₃N₄ film. In the optical device 6, a normalized film thickness x of the first layer 47a is set to 0.45, and the same of the second layer 47b is set to 0.38.

FIG. 17 shows a graph showing a relationship between the incident angle θ and the calculated reflectance in the photodectector 6 where the first layer 47a is formed of Si₃N₄ film and the second layer 47b is formed of SiO₂ film. In this example, the normalized film thickness x of the first layer 47a is set to 0.45, and the same of the second layer 47b is set to 0.38.

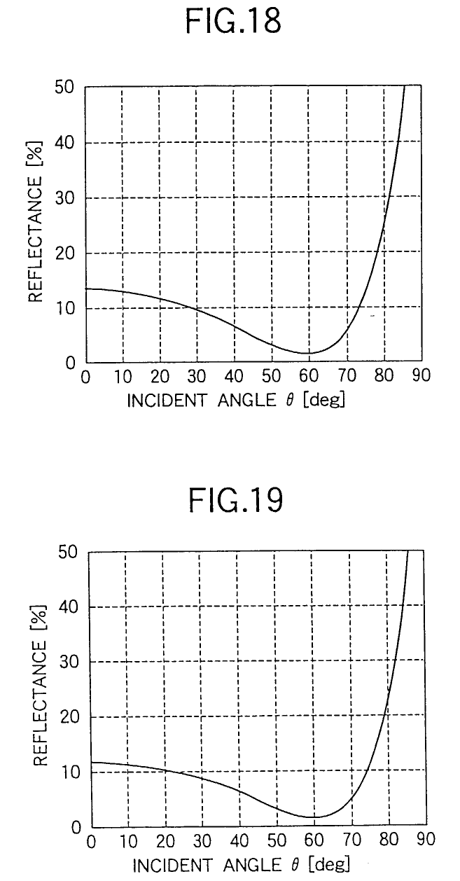

FIG. 18 shows a graph showing a relationship between the incident angle θ and the calculated reflectance in the photodectector 6 where the first layer 47a is formed of Si₃N₄ film and the second layer 47b is formed of Al₂O₃ film (refractive index: 1.63). In this example, the normalized film thickness x of the first layer 47a is set to 0.5, and the same of the second layer 47b is set to 0.35.

FIG. 19 shows a graph showing a relationship between the incident angle θ and the calculated reflectance in the photodectector 6 where the first layer 47a is formed of Si₃N₄ film and the second layer 47b is formed of Al₂O₃ film. In this example, the normalized film thickness x of the first layer 47a is set to 0.6, and the same of the second layer 47b is set to 0.28.

FIG. 20 shows a graph showing a relationship between the incident angle θ and the calculated reflectance in the photodectector 6 where the first layer 47a is formed of Si₃N₄ film, the second layer 47b is formed of Al₂O₃ film and the third layer 47c is formed of SiO₂ film in the structure shown in FIG. 15. In this example, the normalized film thickness x of the first layer 47a is set to 0.05, the same of the second layer 47b is set to 0.6, and the same of the third layer 47c is set to 0.28.

FIG. 21 shows a graph showing a relationship between the incident angle θ and the calculated reflectance in the photodectector 6 where the first layer 47a is formed of Si₃N₄ film, the second layer 47b is formed of Al₂O₃ film and the third layer 47c is formed of SiO₂ film in the structure shown in FIG. 15. In this example, the normalized film thickness x of the first layer 47a is set to 0.1, the same of the second layer 47b is set to 0.5, and the same of the third layer 47c is set to 0.35.

As shown in FIGS. 16 to 21, the reflectance has a local minimum value in the range of large incident angle, from 60 degrees to 70 degrees. In order to indicate such small reflectance, it is required that at least one of plural laminated sub-layers in the outermost layer has a refractive index smaller than √(Nₐ×N_{b}) and at least another one of the plural laminated sub-layers has a refractive index larger than √(Nₐ×N_{b}). In addition, it is preferable that one sub-layer among the laminated sub-layers closer to the photodetecting face is formed of the Si₃N₄ film and another sub-layer farther from the photodetecting face is formed of the SiO₂ film. Under this structure, it can be considered that while easiness of die bonding and wire bonding of the photodetector is secured, sufficient monitor current can be obtained for controlling the output of the semiconductor laser. Moreover, a specific sub-layer like the Si₃N₄ film, which has a large refractive index but excellent passivation can be disposed closer to or directly on the photodetecting face.

Still further, when investigated from another aspect, it is concluded that an inequality N_{b}<N₂<N₁<Nₐ is satisfied in the outermost layer with double layer structure shown in FIG. 14, wherein a sub-layer closest to the photodetecting face of the photodetector has a refractive index N₁ and an outermost sub-layer has a refractive index N₂Specifically, a sub-layer having a refractive index N₁ may be formed of Si₃N₄, and another sub-layer having a refractive index N₂ may be formed of SiO₂ or Al₂O₃. Similarly, it is concluded that an inequality N_{b}<N₃<N₂<N₁<Nₐ is satisfied in the outermost layer with triple layer structure shown in FIG. 15, wherein a sub-layer closest to the photodetecting face of the photodetector has a refractive index N₁, an intermediate sub-layer has a refractive index N₂ and an outermost sub-layer has a refractive index N₃. Specifically, a sub-layer having a refractive index N₁ may be formed of Si₃N₄, another sub-layer having a refractive index N₂ may be formed of Al₂O₃, and another sub-layer having a refractive index N₃ may be formed of SiO₂.

Furthermore, if a specific incident angle such as 60 degrees or 70 degrees being larger than a predetermined value is not indispensable, the present invention can be grasped by still another aspect.

In FIGS. 4, and 10 to 13, the reflectance has at least one local minimum value in the range of the incident angle from 0 degree to 90 degrees. Thus, by adjusting the normalized film thickness (combination of the refractive index and thickness) of the outermost layer appropriately in accordance with the incident angle of the laser beam having a given wavelength, reflection of the laser beam can be suppressed to the minimum. For example, in the case where setting of the incident angle θ to 50 degrees is allowed or forced due to the requirements on the manufacturing process of the optical device, an outermost layer which indicates a minimum reflectance at θ=50° can be optionally elected and adapted. Sufficient monitor current to control the output of the semiconductor laser can be obtained by such adjustment. In other words, even if flexibility of the design for the optical device is low, sufficient monitor current to control the output of the semiconductor laser can be obtained by such adjustment. Hereupon, it could be expected that the combination of the refractive index and the film thickness of the outermost layer is set such that the reflectance of the laser beam indicates its minimum value at a predetermined incident angle of the laser beam. However, the forgoing combination may be set such that the reflectance of the laser beam indicates a minimum value at the vicinity of said predetermined incident angle. Namely, the absolute minimum value of the reflectance in the range from 0 degree to 90 degrees of the incident angle is not always necessary, and an optional value of said combination can be selected so that the reflectance indicates an approximate value of its minimum value.

The adjustment for the location of the photodetector is discussed from still another aspect hereinafter.

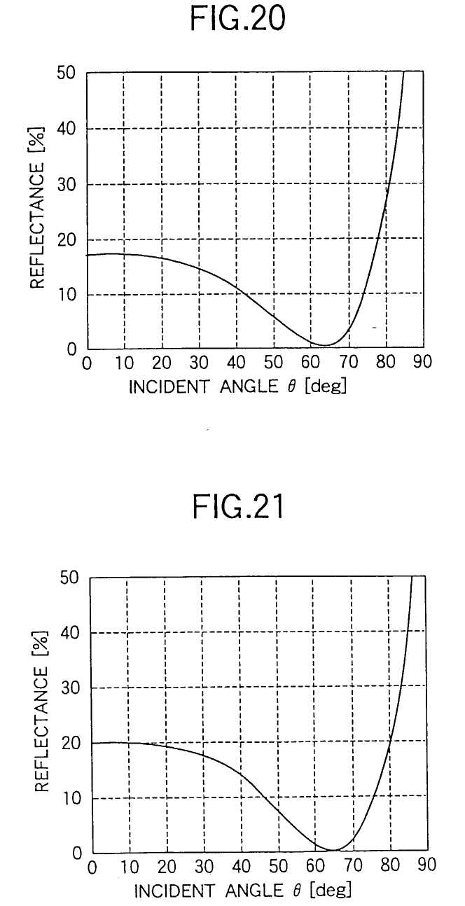

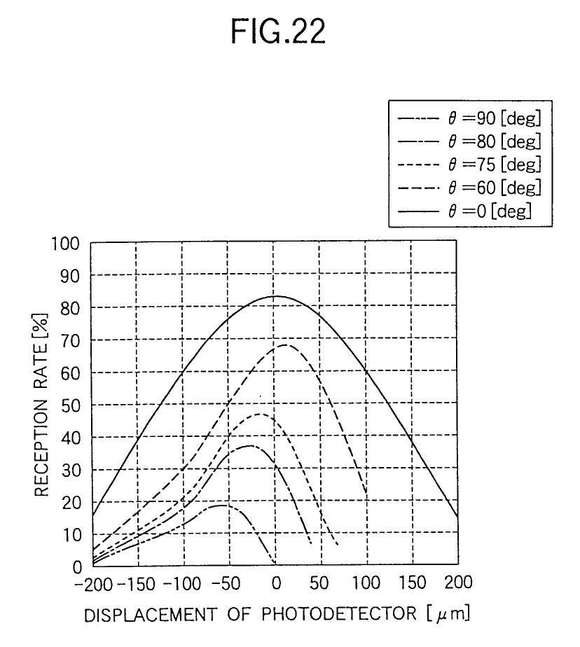

FIG. 22 shows a reception rate of the backward beam B (wavelength λ=1310 nm) emitted from the semiconductor laser 1 by the monitor photodetector 6, wherein an SiO₂ film 47 (film thickness: 300 nm) is formed on the outermost surface of the photodetector 6, the photodetecting face of the photodetector 6 is shaped into circle with a diameter of 300 μm, the distance between the semiconductor laser 1 and the center of the photodetecting face of the photodetector 6 is set to 330 μm.

Each of the curves in FIG. 22 has a common parameter of angle θ defined by the normal line of the photodetecting face and the incident direction of the laser beam. In FIG. 22, the transverse axis represents a displacement amount in the height direction of the photodetector from the position where the center of the photodetecting face of the photodetector is made coincident with the emission point of the semiconductor laser, and the longitudinal axis represents the reception rate of the laser beam.

As shown in FIG. 22, the maximum reception rate of about 37% can be obtained even at θ=80. Thus, the reception rate is improved by about 10% as compared with the general photodetector having an outermost layer the refractive index 1.84 and the film thickness 178 nm, which indicates the reception rate. The monitor current can be also improved by about 10% in response to the improved reception rate.

Further, in FIG. 22, the position of the monitor photodetector at which the reception rate is made maximum is shifted to the minus direction in the case of θ=75°, 80° or 90°. For example, in the case of θ=80°, the maximum reception rate appears at −20 μm. This phenomenon is caused by dependency on the incident angle of reflectance on the photodetecting face. In the case where the photodetecting face of the photodetector is arranged opposed to the semiconductor laser (thus, θ=0°) as in the related art, this phenomenon never happens, and it is a specific phenomenon caused when the photodetecting face of the photodetector is inclined (for example with a large inclination angle like θ=70°). According to the present invention, the monitor photodetector is relatively disposed with respect to the semiconductor laser so that the center of its photodetecting face is located to be offset from a maximum intensity center of the laser beam in such a direction that one end of the photodetecting face closer to the semiconductor laser is apart from the maximum intensity center of the laser beam.

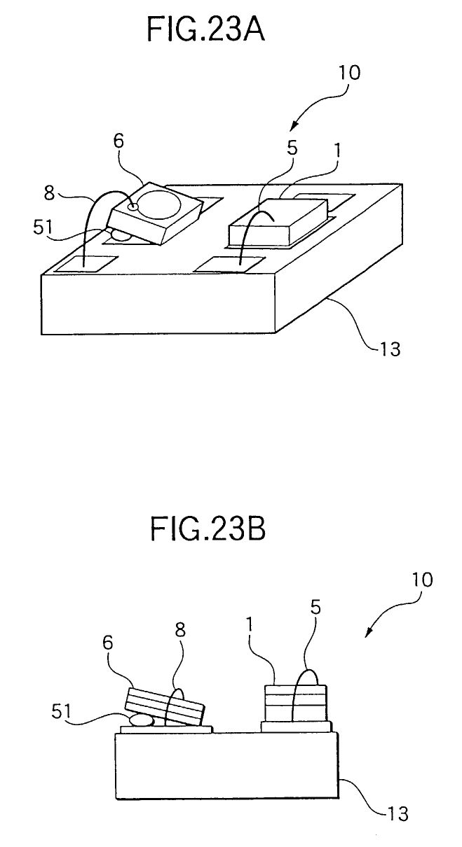

FIGS. 23A and 23B show an optical device 10 according to a second embodiment of the present invention. In this embodiment, one end of the monitor photodetector 6 is fixed on the surface of the substrate 13 via a solder ball 51, and the photodetecting face is designed so as to have a predetermined inclination angle. In other words, a first end of the photodetector 6 is directly fixed on the surface of the substrate 13 and a second end of the photodetector is fixed on the solder ball 51. According to this structure, formation of the groove to be formed on the substrate as shown in the first embodiment can be omitted.

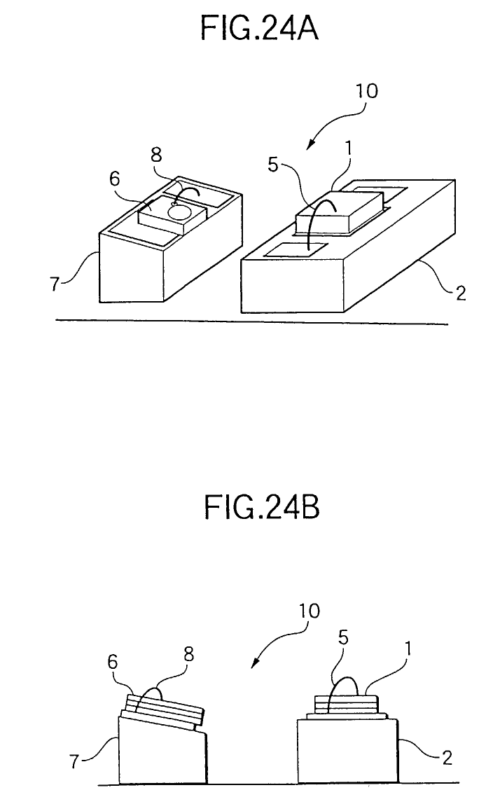

FIGS. 24A and 24B show an optical device 10 according to a third embodiment of the present invention. In this embodiment, the semiconductor laser 1 and the photodetector 6 are mounted on the separate substrates 2 and 7. Even under this structure, the aforementioned effect can be obtained.

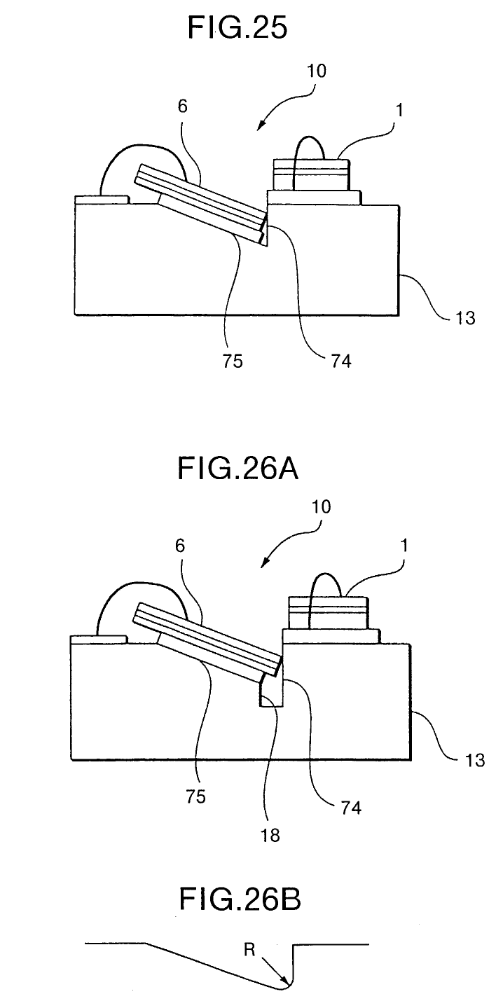

FIG. 25 shows an optical device 10 according to a fourth embodiment of the present invention. At mounting of the monitor photodetector 6 on the substrate 13, the positioning of the photodetector 6 is conducted by general optical processing. Markers for positioning of the photodetector are formed on the substrate, and the photodetector is disposed on the substrate with reference to the markers. Prior to this processing, when the photodetector 6 is mounted on the inclination face 75, its upper corner part is abutted on the rising face 74 as shown in FIG. 25. The position of the photodetector 6 can be determined in the direction on the inclination face 75 by abutment. In the subsequent optical processing, only the positioning of the photodetector 6 in the widthwise direction of the inclination face 75 is conducted. Consequently, this structure facilitates the positioning of the photodetector 6.

FIG. 26A shows an optical device 10 according to a fifth embodiment of the present invention. In the case where the inclination face of the groove for mounting the photodetector is formed on the substrate, a roundness with curvature R is generally formed at the edge of the inclination face as shown in FIG. 26B. If the photodetector is mounted on the roundness area, there is a possible fear that floating of the photodetector to weaken its fixation strength is caused. To solve this problem, a deep groove 18 with a rectangular cross section is formed at an end of the inclination face formed on the substrate as well as at the extension direction of the rising face 74. Thus, the deep groove 18 is formed at one end of the inclination face 75 deeply into the interior of the substrate 13. The roundness at the edge is removed and floating of the photodetector can be solved.

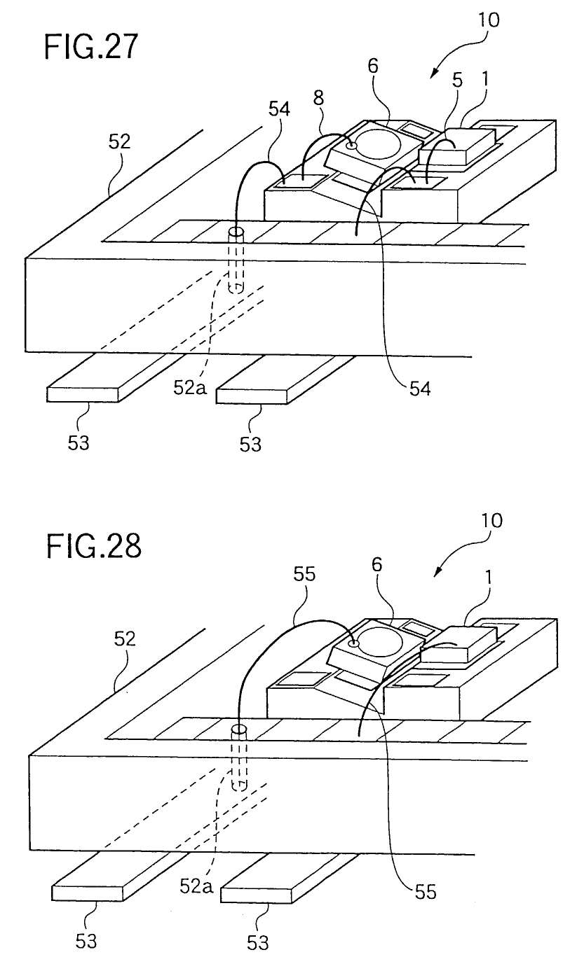

FIG. 27 shows a sixth embodiment of the present invention. An optical device 10 is coupled to a package 52 by wire bonding. Specifically, wires 54 boned to the substrate are inserted into through holes 52a of the package 52, and wires 54 are bonded to lead wires 53 fixed on the package 52.

FIG. 28 shows a seventh embodiment of the present invention. This embodiment is a modification of the sixth embodiment. Specifically, wires 55 bonded to the semiconductor laser 1 and the photodetector 6 are directly bonded to the lead wires 53. This structure simplifies the bonding process. Other points are the same as the sixth embodiment.

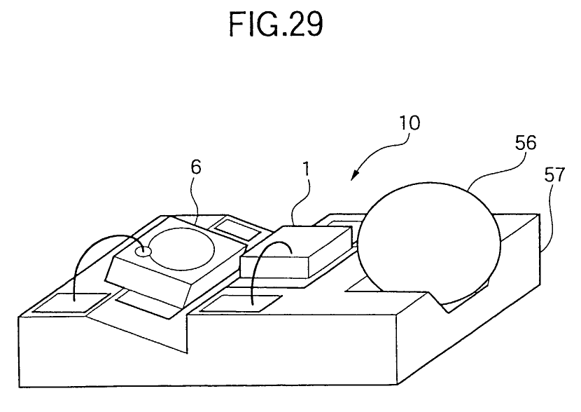

FIG. 29 shows an optical device 10 according to an eighth embodiment of the present invention. A lens 56 is mounted on a substrate 57, and the function for condensing the laser beam (forward beam A in FIG. 1) can be integrally incorporated into the substrate. Manufacturing cost can be reduced under this structure.

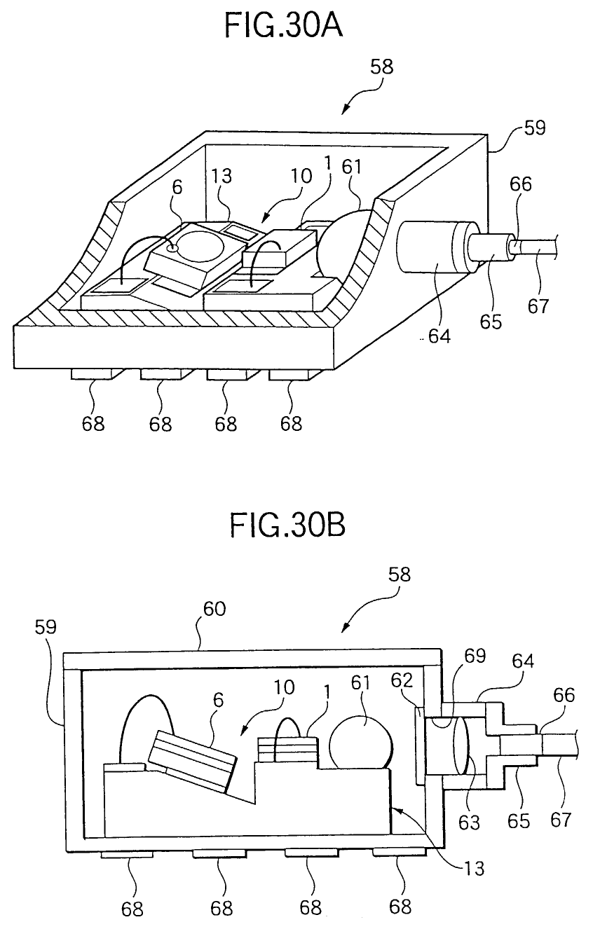

FIGS. 30A and 30B show a ninth embodiment of the present invention. This embodiment shows an optical device module 58 in which the optical device 10 according to the present invention is housed in a case 59 (package). The optical device module is constituted by the optical device 10, the case 59, a cover 60, a sealing glass 62, a second lens 63, a lens holder 64. In addition, lead wires 68 are attached on the bottom surface of the case 59 to secure the external connection. Incidentally, the cover 60 is omitted and a part of the case 50 is removed for convenience of explanation.

The optical device 10 is mounted on a bottom of the case 59, and the upper face of the case 59 is covered by the cover 60. A through hole 69 is formed in one wall of the case 59, and the sealing glass 62 is disposed on the interior side of the case at the through hole 69 to tightly seal the interior of the case 59. The lens holder 64 is attached on an outer side of the one wall of the case 59 at a circumference of the through hole 69, and the second lens 63 is housed within the lens holder 64.

This optical module 58 can be coupled with an optical fiber 67 through a fiber holder 65. A ferrule 66 is fixed to an end of the optical fiber 67, and the optical fiber 67 is attached to the fiber holder 65 via the ferrule 66.

Emission of the laser beam from the optical device module 58 to the optical fiber 67 is conducted as follows. The laser beam (forward beam A in FIG. 1) emitted from the semiconductor laser is condensed by a first lens 61, and transmits through the sealing glass 62 and the through hole 69 to reach the second lens 63. The laser beam is further condensed by the second lens 63 and made incident on the optical fiber 67.

Every kind of optical device according to the present invention may be adapted for the optical device module 58, and the aforementioned effect can be achieved.

Still further, if the present invention is observed from still another aspect, a substrate for mounting an inclined photodetector may be found. Thus, the inclination groove is formed on the substrate to mount the photodetector with an inclined state. This specific structure is a certain subject matter of the present invention. Incidentally, this substrate is generally called “carrier”, so the term of “carrier” is used hereinafter.

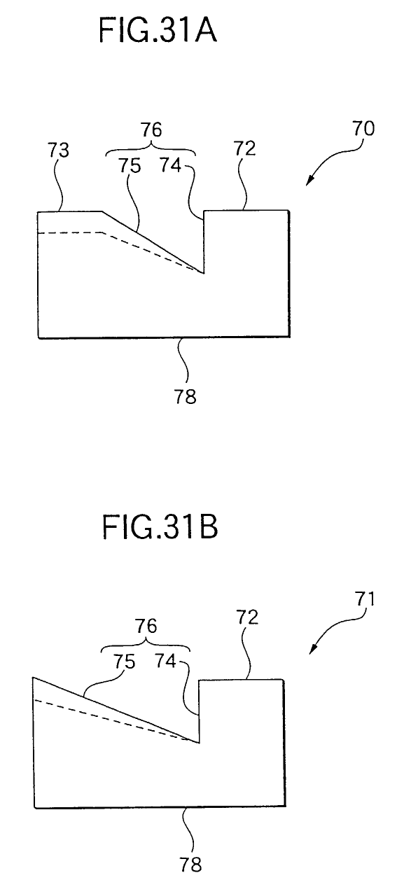

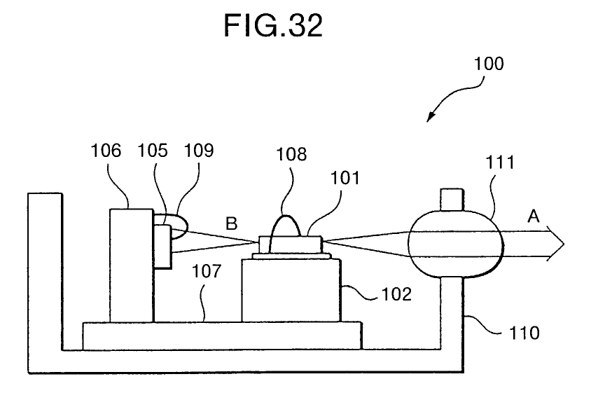

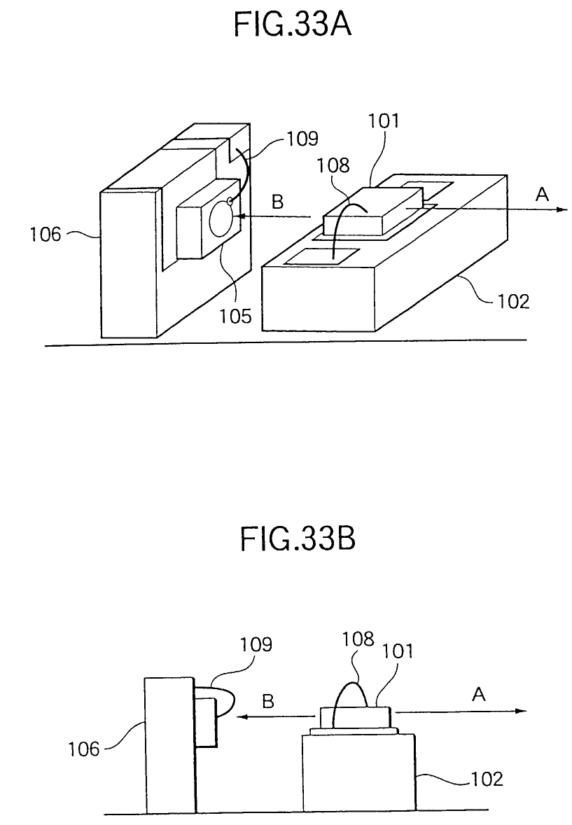

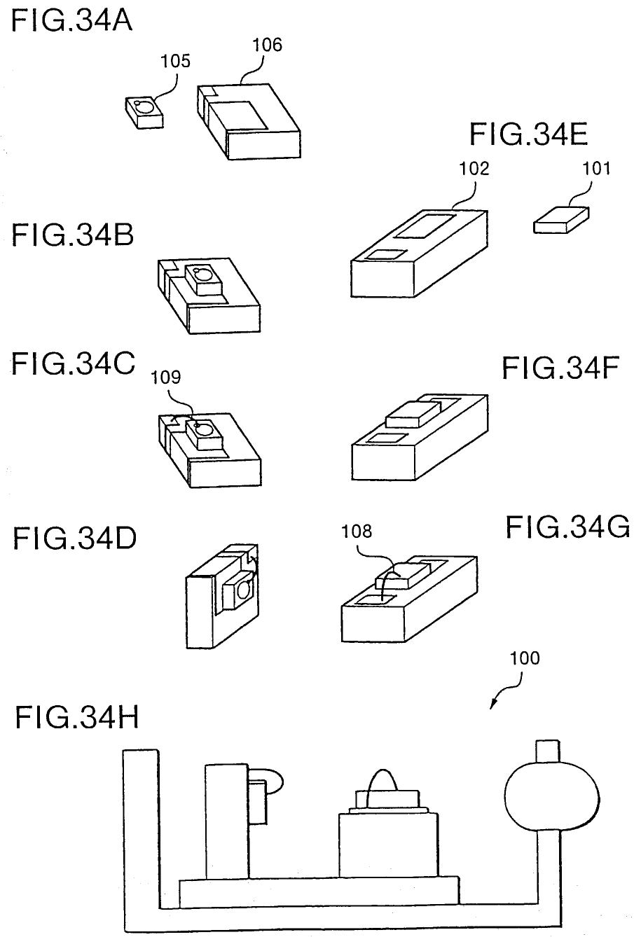

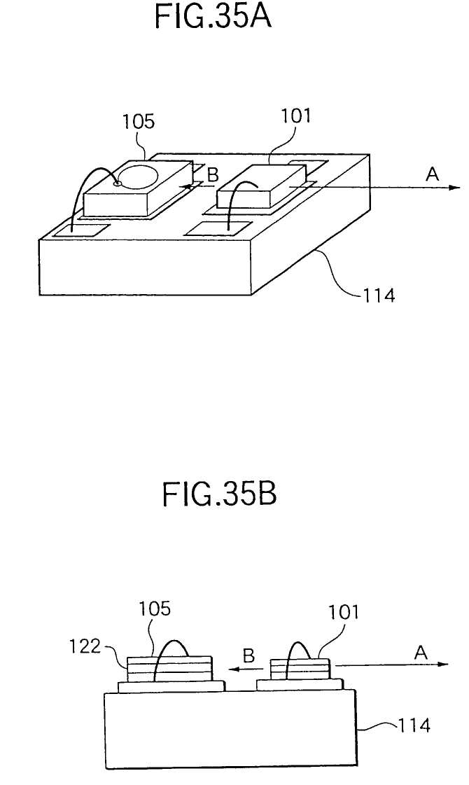

FIGS. 31A and 31B show carriers 70, 71 for the optical device according to the present invention. The carrier 70 shown in FIG. 31A is similar to the forgoing substrate 13 (heat sink). A first flat face 72 for mounting the semiconductor laser thereon and a second flat face 73 employed for the external connection are respectively formed on the upper face of the carrier 70. The inclination groove 76 is formed between the first flat face 72 and the second flat face 73, on which a photodector may be mounted. The inclination groove 76 is constituted by a rising face 74 extending toward a bottom 78 of the carrier 70 substantially perpendicularly from the end of the first flat face 72, and an inclination face 75 extending toward the bottom 78 obliquely from the end of the second flat face 73. Incidentally, the rising face 74 is not necessarily formed perpendicularly from the first flat face 72, and it can be formed obliquely.

In the carrier 71 shown in FIG. 31B, the second flat face 73 is omitted.

Further, as illustrated by dot lines in FIGS. 31A and 31B, the upper end of the inclination face 74 may be located at a lower position than the first flat face so as to be nearer to the bottom 78. The height of the optical device can be reduced and miniaturization is achieved.

Although the invention has been described in its preferred form with a certain degree of particularity, it is understood that the present disclosure of the preferred form can be changed in the details of construction and in the combination and arrangement of parts without departing from the spirit and the scope of the invention.

What is claimed is:

1. An optical device comprising:
a semiconductor laser for emitting a laser beam; and
a photodetector having a photodetecting face to receive the laser beam emitted from said semiconductor laser;
wherein said photodetector is relatively disposed with respect to said semiconductor laser such that a normal line of said photodetecting face crosses an emission direction of the laser beam with an angle in a range of not less than 60 degrees but less than 90 degrees.

2. An optical device according to claim 1, further comprising a single outermost layer having a refractive index N smaller than √(Nₐ×N_{b}) and a normalized film thickness x not less than 0.25 but not more than 0.45, and being formed on said photodetecting face of said photodetector, wherein said normalized film thickness x is represented by x=(N×d)/λ, Nₐ is a refractive index of said photodetecting face, N_{b} is a refractive index of a space through which the laser beam travels, λ is a wavelength of the laser beam, and d is a thickness of said single outermost layer.

3. An optical device according to claim 2, wherein said single outermost layer comprises SiO₂.

4. An optical device according to claim 1, further comprising an outermost layer formed of plural laminated layers and being formed on said photodetecting face of said photodetector.

5. An optical device according to claim 4, wherein at least one of said plural laminated layers in said outermost layer has a refractive index smaller than √(Nₐ×N_{b}), and at least another of said plural laminated layers has a refractive index larger than √(Nₐ×N_{b}), and wherein Nₐ is a refractive index of said photodetecting face and N_{b} is a refractive index of a space through which the laser beam travels.

6. An optical device according to claim 5, wherein one of said plural laminated layers nearer to said photodetecting face comprises Si₃N₄ and another of said plural laminated layers farther from said photodetecting face comprises SiO₂.

7. An optical device according to claim 1, wherein said semiconductor laser and said photodetector are mounted on a single substrate.

8. An optical device according to claim 7, wherein said substrate comprises Si.

9. An optical device according to claim 7, further comprising a solder ball formed on a surface of said substrate, wherein a first end of said photodetector is directly fixed on said surface of said substrate and a second end of said photodetector is fixed on said solder ball.

10. An optical device according to claim 7, wherein an inclination groove is formed on a surface of said substrate, and said photodetector is mounted on an inclination face of said inclination groove.

11. An optical device according to claim 10, wherein said semiconductor laser and said photodetector are bonded to said substrate by wires at a substantially same height with respect to said substrate.

12. An optical device according to claim 10, wherein each of said semiconductor laser and said photodetector is directly bonded to an external package by a wire.

13. An optical device according to claim 10, wherein said inclination groove has said inclination face and a rising face formed from one end of said inclination face to said surface of said substrate, and an upper corner part of said photodetector abuts on said rising face.

14. An optical device according to claim 13, wherein a groove with a rectangular cross section is formed at said one end of said inclination face.

15. An optical device according to claim 7, further comprising a lens mounted on said substrate.

16. An optical device according to claim 1, wherein said photodetector is relatively disposed with respect to said semiconductor laser such that a center of said photodetecting face is located to be offset from a maximum intensity center of the laser beam in such a direction that one end of said photodetecting face closer to said semiconductor laser is apart from the maximum intensity center of the laser beam.

17. An optical device according to claim 1, wherein said photodetector is relatively disposed with respect to said semiconductor laser such that the normal line of said photodetecting face crosses the emission direction of the laser beam with an angle in a range of not less than 70 degrees but less than 90 degrees.

18. An optical device comprising:
a semiconductor laser for emitting a laser beam; and
a photodetector having a photodetecting face to receive the laser beam emitted from said semiconductor laser and an outermost layer being formed on said photodetecting face;
wherein said photodetector is relatively disposed with respect to said semiconductor laser such that an incident angle of the laser beam with respect to said photodetecting face of said photodetector is set in a range of larger than 0 degree but less than 90 degrees, and
wherein a combination of a refractive index and a thickness of said outermost layer is set in accordance with a wavelength of the laser beam such that a reflectance of the laser beam indicates a minimum value at said incident angle of the laser beam or at the vicinity of said incident angle.

19. An optical device module comprising:
a case;
an optical device mounted on a bottom of said case;
a cover covering an upper face of said case;
a sealing glass covering a through hole formed in one wall of said case from an interior of said case;
a lens holder attached on an outer side of said one wall of said case at a circumference of said through hole; and
a second lens accommodated in said lens holder; and
said optical device comprising:
a substrate mounted on said bottom of said case;
a semiconductor laser mounted on said substrate to emit a laser beam;
a photodetector mounted on said substrate to monitor the laser beam emitted from said semiconductor laser to control an output of the laser beam; and
a first lens mounted on said substrate to condense the laser beam emitted from said semiconductor laser;
wherein said photodetector has a photodetecting face to receive the laser beam, and said photodetector is relatively disposed with respect to said semiconductor laser on said substrate such that a normal line of said photodetecting face crosses an emission direction of the laser beam with an angle in a range of not less than 60 degrees but less than 90 degrees.

20. A carrier for an optical device, which is adapted for mounting thereon a semiconductor laser and a photodetector to monitor the laser beam emitted from said semiconductor laser to control an output of the laser beam, said carrier comprising:
a bottom;
a first flat face formed opposite to said bottom and being adapted for mounting said semiconductor laser thereon; and
an inclination groove having an inclination face and a rising face;
wherein said rising face is formed from said first flat face toward said bottom, and said inclination face is formed to be inclined with respect to said first flat face and being adapted for mounting said photodetector thereon.

21. A carrier for an optical device according to claim 20, further comprising a second flat face, said inclination groove being formed between said first flat face and said second flat face.

22. A carrier for an optical device according to claim 20, wherein an upper end of said inclination face is located at a nearer position to said bottom than said first flat face.
